(19) United States
(12) Patent Application Publication
(10) Pub. No.: US 2021/0248677 A1
(43) Pub. Date: Aug. 12, 2021

(54) Cloud solutions as capital

(71) Applicants: Mickey Gsell, Trussville, AL (US); Aron Elston, Fort Mill, SC (US)

(72) Inventors: Mickey Gsell, Trussville, AL (US); Aron Elston, Fort Mill, SC (US)

(21) Appl. No.: 16/786,557

(22) Filed: Feb. 10, 2020

(51) Int. Cl. G06Q 40/04; G06Q 20/12; G06Q 30/06; G06Q 20/14; G06Q 10/10; G06Q 50/18; G06Q 20/38; H04L 9/08; H04L 9/06

(52) U.S. Cl. CPC G06Q 40/04; G06Q 20/1235; G06Q 20/127; G06Q 30/0645; G06Q 20/14; H04L 2209/38; G06Q 50/18; G06Q 20/3829; H04L 9/0819; H04L 9/0637; G06Q 2220/18; G06Q 10/10

(57) ABSTRACT

This disclosure is directed to a methods and processes which include buying and selling cloud-based, for example, SaaS solutions, as capital through the application, in one example, of a contract/deed process. The disclosed methods and processes provide access to a cloud solution, or assets located in a remote data center, for a specified period and may be sold as capital to cover a period of time. In embodiments, the sale of access to a cloud solution, or assets located in a remote data center, can be accomplished, as mentioned, using legal contracts or deeds via standard methods, and may also leverage Blockchain contract technology to provide an automated secure method of tracking and updating the contracts.

### BACKGROUND OF THE DISCLOSURE

### Field of the Invention

This disclosure is directed to methods and capital assets that provide access to a cloud solution, or assets located in a remote data center, which are bought and sold as capital optionally covering a period of time.

### Description of the Related Art

For many companies, for example utility companies, budgets are managed and allocated in two different categories: Capex (capital expenditures) and Opex (operational expenditures) aka. Operations & Maintenance (O&M). For yearly budgets, organizations may be allotted to spend a certain amount on Capex and a smaller percentage of that is allocated to Opex. This causes issues with vendors who provide SaaS (software as a service) offerings as cloud services, which are classified as purely Opex, since there is no license which is owned, and all the hardware is owned and operated by the cloud provider. Conventional subscription-based services, therefore, lock customers into spending their budgets utilizing operational expenses.

Conventionally, SaaS cloud services are provided on a subscription basis with charges/payments made, for example, monthly.

### SUMMARY OF THE INVENTION

This disclosure is directed to a methods and processes which include buying and selling cloud-based services; as one example, SaaS solutions, as capital through the implementation, in one example, of a contract/deed process. The disclosed methods and processes provide access to a cloud solution, or assets located in a remote data center, for a specified period and may be sold as capital to cover a period of time. In embodiments, the sale of access to a cloud solution, or assets located in a remote data center, can be accomplished, as mentioned, using legal contracts or deeds via standard methods, and may also leverage Blockchain contract technology to provide a secure method of tracking the ownership of the contracts.

Other features and aspects will be apparent from the following detailed description, the drawings, and the claims.

### BRIEF DESCRIPTION OF THE DRAWINGS

FIG. 1 shows one embodiment of a solution overview.

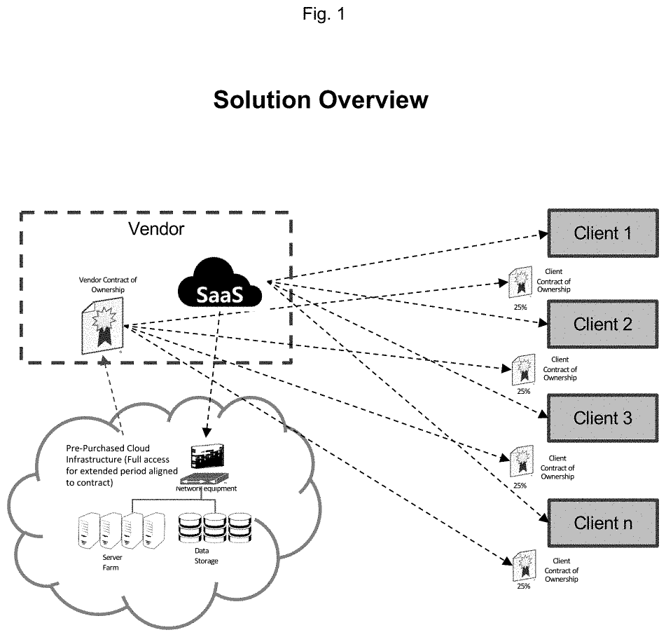

FIG. 2 shows Examples of implementation.

### DETAILED DESCRIPTION

The following detailed description is provided to assist the reader in gaining a comprehensive understanding of the methods, products, and/or systems described herein. However, various changes, modifications, and equivalents of the methods, products, and/or systems described herein will be apparent to an ordinary skilled artisan.

Methods and processes are disclosed which include buying and selling cloud-based, for example SaaS solutions, as capital through the application of, in embodiments, a contract or deed. The disclosed methods and processes may provide access to SaaS cloud solutions, or access to assets located in a remote data center, for a specified period and may be sold as capital to cover, for example, a period of time. In embodiments, the sale of the access to a cloud solution, or assets located in a remote data center, can be accomplished, as mentioned, using legal contracts or deeds or other standard methods, and may also leverage Blockchain contract technology to provide a secure method of tracking the ownership of the contracts.

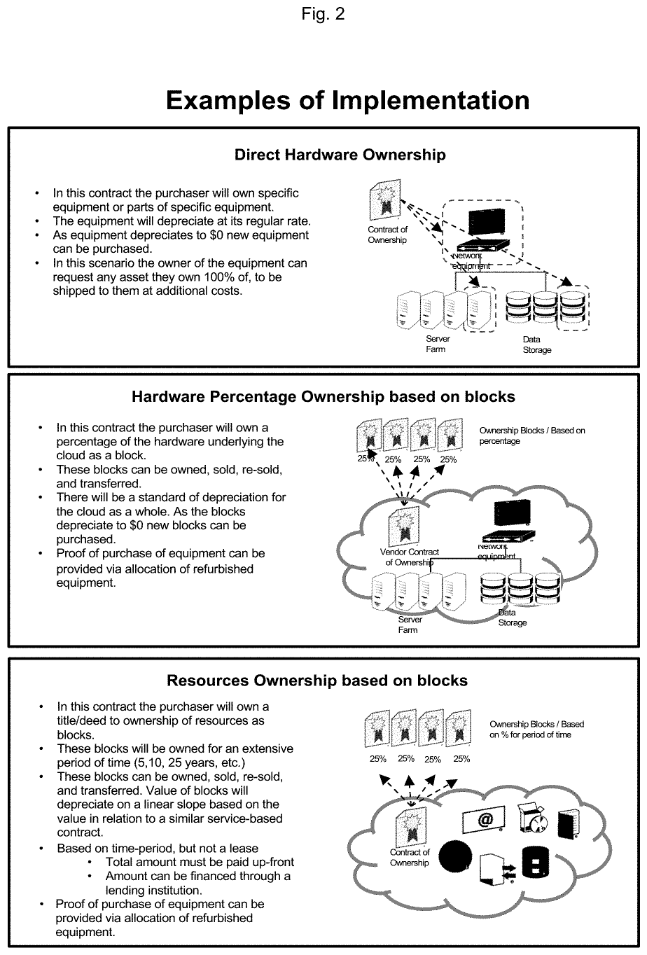

In embodiments, examples of implementation include direct hardware ownership, hardware percentage ownership based on blocks and software/resources ownership based on blocks. See e.g., FIG. 2. Cloud computing clients sell blocks that represent shares of actual physical equipment (servers, firewalls, network switches, SAN's, etc.) or computing power (processors, memory, storage, etc.). These blocks may or may not be time limited and may be owned, sold, re-sold, and transferred. Each contract may hold the details of the cloud computing solution and the ownership of the assets as defined by the deed and/or contract and can be transferred to a new owner via a new contract and/or deed properly signed and transferred according to applicable legal requirements.

When utilizing blockchain, details of the blocks and access rights may be stored in the blockchain and held by clients via private keys that may be distributed utilizing standard blockchain technology. Ownership of the keys and transfer of the assets may occur via a certified blockchain transaction with both parties signing and agreeing for the transfer of the relevant assets. These private keys may be legally held and permit access to a Blockchain contract providing a concise record of transfer of any assets from one party to another. Holding of such keys may be considered authority for ownership and for access to the assets.

In the case of smart contracts for the purpose of tracking use and ownership of a cloud-based solution the application would utilize automated triggers that would automatically bill the owner in order to gain access to more of the overall solution. Also, in the case that an owner proactively requests greater access and/or wants to extend the contract, the blockchain solution would be able to handle all situations to handle this through programmatic and/or robotic processes.

The disclosed methods and processes permit SaaS type vendors to sell cloud solutions as capital. This would allow businesses the ability to use cloud solutions, and align budgets, in a more concise and effective way.

Capital or capital assets may be assets of a business found on a balance sheet. Capital assets as used herein includes equipment and hardware including computer hardware and equipment such as servers, firewalls, network switches, SAN's, etc. and processors, memory, storage, etc., and also conventionally includes cash, cash equivalents, and marketable securities as well as manufacturing and production equipment and hardware, production facilities, storage facilities, etc.

Cloud services as used herein generally encompasses all internet-based cloud services including software as a solution (SaaS) cloud-based services.

While this disclosure includes specific examples, it will be apparent after an understanding of the disclosure of this application has been attained that various changes in form and details may be made in these examples without departing from the spirit and scope of the claims and their equivalents.

What is claimed is:

1. A method of providing cloud services comprising selling shares of computer hardware and/or computing power as capital.

2. The method of claim 1, wherein the computer hardware comprises servers, firewalls, network switches, and/or computer storage area networks (SANs).

3. The method of claim 1, wherein the computing power comprises processors, memory, and/or storage.

4. The method of claim 1, wherein the shares are sold in share blocks.

5. The method of claim 1, wherein ownership of the shares is transferred by deed and/or contract.

6. The method of claim 1, wherein ownership of the shares is for a limited period of time.

7. The method of claim 5, wherein the transfer is accomplished by Blockchain technology.

8. Capital assets comprising computer hardware and/or computing power.

9. The capital assets of claim 8, wherein the computer hardware comprises servers, firewalls, network switches, and/or computer storage area networks (SANs).

10. The capital assets of claim 8, wherein the computing power comprises processors, memory, and/or storage.

11. The method of claim 7, wherein automated triggers automatically bill an owner in order to purchase more of the cloud services.

12. The method of claim 6, wherein extending ownership for a longer time is handled through programmatic and/or robotic processes.
